(19) United States
(12) Patent Application Publication
(10) Pub. No.: US 2015/0122651 A1
(43) Pub. Date: May 7, 2015

(54) Method and Fluidic Microsystem for Generating Droplets Dispersed in a Continuous Phase

(71) Applicant: Max-Planck-Gesellschaft zur Foerderung der Wissenschaften e.V., Muenchen (DE)

(72) Inventors: Jean-Christophe Baret, Goettingen (DE); Say Hwa Tan, Goettingen (DE); Benoit Semin, Goettingen (DE)

(21) Appl. No.: 14/389,650

(22) PCT Filed: Mar. 30, 2012
(86) PCT No.: PCT/EP2012/001423

§ 371 Date: Jan. 22, 2015

(51) Int. Cl. B01L 3/00; B01F 13/00

(52) U.S. Cl. CPC B01L 3/502784; B01L 3/502715; B01F 13/0076; B01L 2300/0627
USPC 204/452; 204/451; 204/601; 204/602

(57) ABSTRACT

A method of generating droplets of a dispersed phase fluid in a continuous phase fluid includes flowing the dispersed phase fluid and the continuous phase fluid to a channel junction of at least one dispersed phase channel and at least one continuous phase channel, applying at least one alternating voltage to at least two electrodes so that an alternating electric field is created at the channel junction, and generating the droplets of the dispersed phase fluid in the continuous phase fluid flowing in an output channel of the channel junction, wherein the dispersed phase fluid and the continuous phase fluid are electrically insulated from the at least two electrodes. Furthermore, a microfluidic device is described, which is configured for generating droplets of a dispersed phase fluid in a continuous phase fluid.

The invention relates to a method of generating droplets of a dispersed phase fluid in a continuous phase fluid at a junction of channels of a microfluidic device, wherein the droplets are generated under the control of an alternating electric field. Furthermore, the invention relates to a microfluidic device, which is configured for generating droplets of a dispersed phase fluid in a continuous phase fluid, wherein the microfluidic device includes a junction of microfluidic channels and multiple electrodes are arranged for creating an alternating electric field at the junction. In particular, the invention relates to the active control of droplet generation in microfluidic devices using alternating electric fields. Applications of the invention are available in the fields of for example lab-on-chip platforms, biochemical analyses, biochemical assays, cell sorting systems, cell encapsulation or material synthesis.

Droplets generated in microfluidic devices provide an attractive tool for many chemical, in particular biochemical applications as the droplets can be generated with discrete volumes of fluids to be individually handled and manipulated. Each droplet can act as an independent micro-reactor in which reactions can be processed at a high throughput rate of e.g. several droplets per millisecond. As another advantage, the high surface area to volume ratio in droplets can be used to enhance reaction rates, or to favour heat or material exchange.

It is generally known that droplets can be generated by flowing immiscible fluids into microfluidic channels of a microfluidic device, which are joint at a channel junction. The fluids flow to the junction, where the droplets of one of the fluids (dispersed phase fluid) are produced in the other fluid (continuous phase fluid). The droplet diameter and frequency of the droplet generation are determined mainly by the geometry of the channels, the flow rates of the fluids and fluid properties like viscosity and surface tension (see e.g. P. Garstecki et al. in “Lab on a chip”, volume 6, 2006, p. 437-446, or L. A. Shelley et al. in “Applied Physics Letters”, volume 82, 2003, p. 364-366).

It is possible to tune the droplet diameter by adapting flow rates to the channels. However, the extended response time of the microfluidic system, which typically is in the range of minutes due to the use of syringe pumps, does not enable a controlled on-demand modification of droplet volumes at the rate of single droplets. Therefore, more versatile and reliable methods of droplet generation by applying external forces on the microfluidic device have been proposed. As an example, pneumatic valves have been used for controlling the droplet generation (A. R. Abate et al. in “Lab on a Chip”, volume 96, 2010, p. 203509). However, the pneumatic activation of droplet generation is limited in frequency, typically in the range below 100 Hz. Another approach is based on applying heat for controlling the droplet generation (S.-H. Tan et al. in “Journal of Physics D: Applied Physics”, volume 41, 2008, p. 165501), which however is poorly compatible with biological assays, where temperature is a key parameter to be controlled. The external force also can be created by magnetic fields (S.-H. Tan et al. in “J. Micromech. Microench.”, volume 20, 2010, article number 045004). As a disadvantage, the magnetic activation requires the dispersion of magnetic particles in the fluids, which restricts the range of applications.

The most providing conventional approaches for controlling the droplet generation are based on the application of electric fields at the location of droplet generation (H. Gu et al. in “Applied Physics Letters”, volume 93, 2008, p. 183507; H. Kim et al. in “Applied Physics Letters”, volume 91, 2007, p. 133106; D. R. Link et al. in “Angewandte Chemie, International Edition”, volume 45, 2006, p. 2556-2560; and C.-H. Yeh et al. in “Microfluidics Nanofluidics”, volume 12, 2011, p. 475-484). Some of the previous works showed how droplet generation can be externally controlled using electrowetting or electrospraying. However, with these techniques, the reliability and the flexibility of the systems poses a major concern to many users. As an example, in the conventional systems, the use of direct voltage (DC) results in long-term shielding of the field by charge build-up at interfaces. In addition, the formation of debris which often clogs the channels and the production of unwanted bubbles (electrolysis) leads to an unstable droplet generation. Furthermore, these conventional systems are also not truly flexible as they offer only single mode of droplet manipulation (only decreasing the size of droplets produced). It is also known to use alternating voltages (AC) for manipulating dispersed droplets in a microfluidic device (J.-C. Baret et al. in “Lab on a Chip”, volume 9, 2009, p. 1850-1858) or for influencing the droplet generation in a microfluidic device (US 2006/0163385 A1).

A general disadvantage of the conventional droplet generation control using electric fields is related to the fact that these techniques require an electrode, which is positioned in one of the microfluidic channels in contact with the fluids (US 2006/0163385 A1, or H. Kim et al., cited above). Accordingly, unintended electro-chemical reactions may occur at the electrode. The chemical composition of the fluids can be changed. Furthermore, as the conventional techniques typically are based on the electrospraying principle, charged droplets are generated, which can show unintended interactions and which may require an additional discharging step.

The objective of the invention is to provide an improved method of generating droplets of a dispersed phase fluid in a continuous phase fluid, wherein disadvantages of conventional droplet generation techniques are avoided and which in particular has an enlarged range of application. In a further aspect, the objective of the invention is to provide an improved microfluidic device, which is configured for generating droplets of a dispersed phase fluid in a continuous phase fluid and which is capable of avoiding disadvantages of conventional techniques. In particular, the objective of the invention is to provide an improved droplet generation method and/or device, having an increased flexibility of droplet control and/or the capability of minimizing or completely suppressing changes of the fluids.

The above objectives are solved by a method and a microfluidic device for generating droplets having the features of the independent claims, respectively. Preferred embodiments and applications of the invention are defined in the dependent claims.

According to a first general aspect of the invention, a method of generating droplets of a dispersed phase fluid in a continuous phase fluid is provided, wherein the dispersed phase fluid and the continuous phase fluid flow through separate microfluidic channels to a channel junction in a microfluidic device and the droplets are generated under the influence of an alternating electric field, which is created at the channel junction by applying at least one alternating voltage to at least two electrodes of the microfluidic device. According to the invention, the dispersed phase fluid and the continuous phase fluid are electrically isolated from the at least two electrodes.

The dispersed phase fluid and the continuous phase fluid flow through at least one dispersed phase channel and at least one continuous phase channel of the microfluidic device, resp. The channel junction is formed where the at least one dispersed phase channel and the at least one continuous phase channel join each other into a common output channel of the channel junction.

The at least two electrodes are arranged adjacent to the channel junction embedded in at least one component of the microfluidic device such that there is no electric contact between any of the electrodes and the inner space of the channels.

According to a second general aspect of the invention, a microfluidic device is provided, which is configured for generating droplets of a dispersed phase fluid in a continuous phase fluid, preferably with a method according to the above first aspect of the invention. The microfluidic device comprises multiple channels, which join at a channel junction. At least one of the channels is a dispersed phase channel arranged for flowing the dispersed phase fluid to the junction, while at least one further channel is a continuous phase channel being arranged for flowing the continuous phase fluid to the junction. The at least one dispersed phase channel and the at least one continuous phase channel open to an output channel. The output channel is arranged for accommodating the flow of the continuous phase fluid including the droplets of the dispersed phase fluids. Furthermore, the microfluidic device includes at least two electrodes to which at least one alternating voltage can be applied.

The at least two electrodes are arranged for creating an alternating electric field at the channel junction. Accordingly, the at least two electrodes typically are arranged adjacent to the channel junction. According to the invention, the channels of the microfluidic device, in particular the at least one dispersed phase channel, the at least one continuous phase channel and the output channel are electrically insulated from the at least two electrodes. The electrodes are electrically shielded against the channels, e.g. by the material of components of the microfluidic device and/or by additional insolating layers covering the electrodes.

According to the invention, a contact-less geometry of electrodes in a microfluidic device for influencing the droplet generation at a channel junction is proposed, wherein the fluids do not have a contact with the electrodes. The inventors have found that an electric contact of the electrodes with the fluids as required with the conventional electrowetting and electrospraying techniques is not necessary for controlling the droplet generation. With the invention, a new process of droplet generation has been proposed, wherein the droplets are influenced contact-free by field effects, in particular by electrocapillarity and/or dielectrophoretic forces. Accordingly, the following main advantages are obtained. First, any electro-chemical reaction between the electrodes and the fluids are avoided. Furthermore, restrictions of conventional techniques in terms of conductivity of the fluids and charging of droplets are avoided. Accordingly, the invention provides an extended range of application of the electrically influenced droplet generation.

Unlike the existing electrical approaches to manipulate the droplet generation, the invention provides a truly robust, fast and reliable technique of generating the droplets, in particular for setting the size and frequency thereof. Any problems with regard to debris and bubbles are avoided. Stable operation of inventive devices has been shown for several hours.

The invention can be implemented with any type of microfluidic devices including microfluidic channels arranged for carrying fluids, like e.g. pure liquids or suspensions. Typically, the microfluidic channels have a rectangular cross-sectional shape with dimensions below 1 mm×1 mm, in particular below 500 μm×500 μm, like e.g. below 100 μm×50 μm. Furthermore, the invention can be implemented with substantially all fluids having a conductivity and viscosity of practical interest. Droplet volumes below 1 nl can be obtained, which make the invention compatible with miniaturization of biochemical assays.

Furthermore, the dispersed phase fluid and the continuous phase fluid may be any combinations of immiscible liquids, in particular pure liquids or suspensions. Preferably, in particular with applications in biology or biochemistry, one of the dispersed phase fluid and the continuous phase fluid is an aqueous liquid, while the other one of the dispersed phase fluid and the continuous phase fluid is an oily liquid. According to an alternative example, in particular with applications in material sciences, immiscible oily liquids can be used as dispersed and continuous phase fluids.

Preferably, the generated droplets of the dispersed phase fluid are electrically neutral. The droplets are non-charged. As an advantage, mutual interactions of droplets, interactions of the droplets with components of the microfluidic device and unintended influences on the substances, e.g. biological material, in the droplets are avoided.

According to a preferred embodiment of the invention, the electric field at the junction is created by applying an offset-free alternating voltage to the at least two electrodes. According to this embodiment of the invention, the mean voltage applied to the electrodes is zero. On the contrary, the conventional electrospraying techniques need an offset of the signal for obtaining a sufficient droplet-droplet repulsion.

As a further advantage of the invention, there are no restrictions in terms of the channel junction geometry. According to a particular preferred embodiment of the invention, the channel junction is a cross-junction formed by one dispersed phase channel and two continuous phase channels opening into the output channel. The channels can be arranged in one common plane, or the channels pairwise may span different planes relative to each other. Furthermore, the channels can be oriented perpendicular relative to each other, or the dispersed phase fluid and continuous phase fluid channels may be mutually angled with an angle below or above 90°. For improved efficiency, the dimensions can be tuned in such a way that the mode of droplet production in the absence of electric field is either dripping or squeezing.

According to an alternative embodiment of the invention, the channel junction may be a T-junction, wherein one dispersed phase channel and one continuous phase channel open into the common output channel. As a further alternative embodiment of the invention, a coaxial jet junction can be provided, wherein the dispersed phase channel is coaxially arranged in the continuous phase channel.

As a further advantage of the invention, the frequency and the voltage of the at least one alternative voltage applied to the at least two electrodes can be selected in broad ranges. With a preferred variant of the invention, the inventors have found that the frequency of the at least one alternating voltage is at least five times larger than a frequency of droplet generation. In a practical example, if about 150 droplets are generated per second, the preferred minimum field frequency is about 750 Hz. With another example, if the droplet frequency is about 1000 droplets per second, the preferred minimum field frequency is 5 kHz.

In absolute terms, the frequency of the at least one alternating voltage is at least 5 Hz, preferably at least 1 kHz, particularly preferred at least 10 kHz. Furthermore, a maximum frequency of the at least one alternating voltage is selected to be at most 1 GHz, preferably at most 100 kHz, particularly preferred at most 50 kHz. Frequencies in particular in the range from 1 kHz to 50 kHz are preferred as state of the art equipment is easily available for such frequencies and voltages. Depending on the application of the invention, field frequencies resulting in microwave heating of the fluids are avoided.

According to further preferred features of the invention, the at least one alternating voltage applied to the at least two electrodes has an amplitude (peak-to-peak-voltage) of at least 100 V, preferably at least 500 V. On the other hand, a maximum amplitude may be selected to be at most 2000 V, preferably at most 1000V. These preferred examples refer to preferred distances between the electrodes in a range of about 100 μm to 200 μm.

With smaller distances, lower voltages can be used, e.g. at least 20 V, thus presenting advantages in particular for the generation of smaller droplets sizes. On the other hand, a maximum voltage can be determined by the electrical breakdown of the component material of the microfluidic device, e.g. the polymer PDMS, and the continuous phase fluid, like e.g. an oil, which is about 15 MV/m corresponding to a voltage of about 2200 V across a distance of electrodes of 150 μm.

It is a particular advantage of the invention that there is no minimum conductivity of the fluids for which the invention would work. The electrical conductivity of the dispersed phase fluid is equal or above 0 μS/cm, preferably at least 0.3 μS/cm (pure water). On the other hand, the continuous phase fluid preferably is non-conducting. The maximum electrical conductivity of the dispersed phase fluid is preferably at most 3000 μS/cm, particularly preferred at most 30 000 μS/cm. However, the invention is not restricted to these preferred examples, but rather capable to work even at higher conductivities.

The droplets are generated with a droplet frequency, which depends on the flow rates of the dispersed phase fluid and the continuous phase fluid and which can be selected in a broad range. According to preferred embodiments of the invention, the droplet frequency is at least 1 Hz, preferably at least 10 Hz. Thus, generating droplets according to the invention can be used e.g. for high speed generation of emulsions. Furthermore, the droplet frequency preferably is at most 10 kHz, e.g. at least 1 kHz.

The inventors have found that the effect of the electric field can be improved, if the electric field is oriented in parallel with a flow direction in the output channel of the channel junction. To this end, according to a further preferred embodiment of the invention, shaping of the at least two electrodes and/or adjusting the at least one alternating voltage are provided such that the alternating electric field is oriented towards the output channel direction.

According to a further preferred embodiment of the invention, the electrodes of the microfluidic device comprise a first electrode pair located upstream of the channel junction and a second electrode pair located downstream of the channel junction. With the cross-junction embodiment of the invention, the first electrode pair is located on both sides of the dispersed phase channel. With the coaxial jet embodiment of the invention, the electrodes of the first electrode pair are located on opposite sides of the coaxial arrangement of the dispersed phase channel and the continuous phase channel. With a T-junction embodiment, the electrodes of the first electrode pair are located on opposite sides of the dispersed phase channel or the continuous phase channel. In all cases, the electrodes of the second electrode pair preferably are located on opposite sides of the output channel. The provision of the two electrode pairs has advantages in terms of creating an electric field having symmetry with regard to the output channel.

According to a particularly preferred embodiment of the invention, the same voltage is applied to the electrodes of each of the first and second electrode pairs, respectively. This embodiment of the invention has particular advantages for the field symmetry with the cross-junction and coaxial jet junction embodiments.

Furthermore, with a particular preferred embodiment of the invention, the first electrode pair or the second electrode pair is connected to ground potential. With this embodiment, the application of the alternating voltage and the droplet generation control are facilitated.

According to a further advantages feature of the invention, the microfluidic device can be provided with a backplate electrode, which is connected with ground. The backplate electrode is arranged on a bottom side of a microfluidic device below the channel junction. As an example, the backplate electrode may be formed by a layer of ITO (Indium Tin Oxide) created on a surface of the microfluidic device. Advantageously, the backplate electrode provides an additional degree of freedom for controlling the droplet generation.

Preferably, the electric field is created such that a location of maximum field strength is within the junction or slightly downstream thereof, where the droplets of the dispersed phase fluid are generated. The electric field is adjusted, e.g. by shaping the electrodes with tips facing to the channel junction, such that the maximum field strength is created at the position of separating the dispersed phase fluid droplets from the inflowing dispersed phase fluid. Advantageously, this embodiment of the invention provides an improved effect of the electric field. According to a further preferred feature of the invention, the electrodes of the microfluidic device have a thickness equal to a height of the channels at the channel junction.

The inventors have found that the size of the droplets generated under the influence of the alternating electric field depends on the strength of the electric field and of the field frequency at the channel junction. The inventors have found that the droplet diameter can be increased or decreased depending on voltage amplitude and the channel junction design. Accordingly, with a particularly preferred embodiment of the invention, the method of generating the droplets includes a step of adjusting the droplet diameter by setting at least one of the amplitude and the field frequency of the at least one alternating voltage applied to the electrodes.

According to a particularly preferred embodiment of the invention, a feedback loop can be provided. The droplet diameter can be stabilized by measuring the current droplet diameter or the current droplet frequency, e.g. with an optical measuring device or electrical measurement (e.g. impedance measurement), and adjusting the alternating voltage amplitude and/or field frequency for obtaining a predetermined droplet diameter to be created. Thus, the monodispersity of an emulsion can be improved with the invention.

Further advantages and details of the invention are described in the following with reference to the attached drawings, which show in:

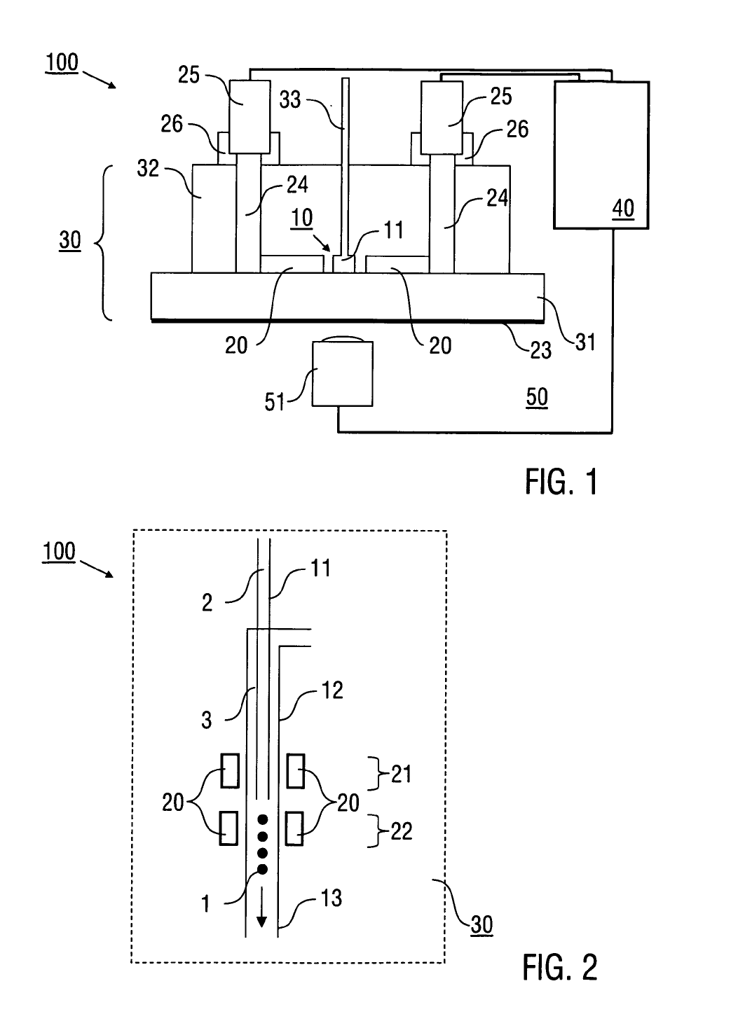

FIG. 1: an embodiment of the microfluidic device according to the invention;

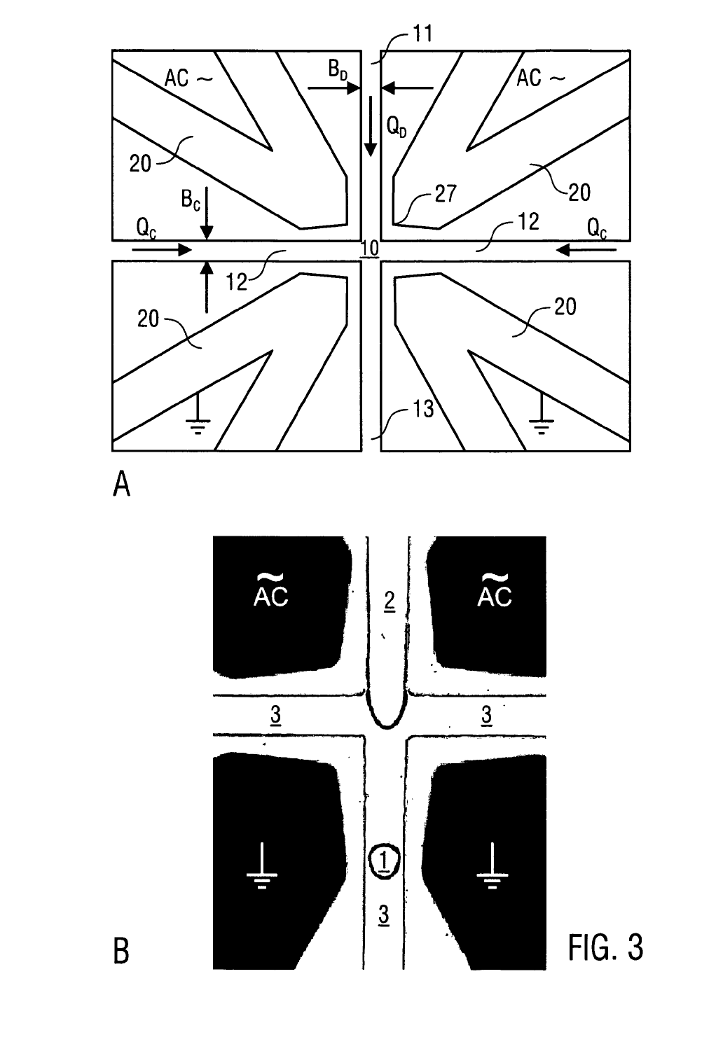

FIG. 2: a further embodiment of the microfluidic device according to the invention;

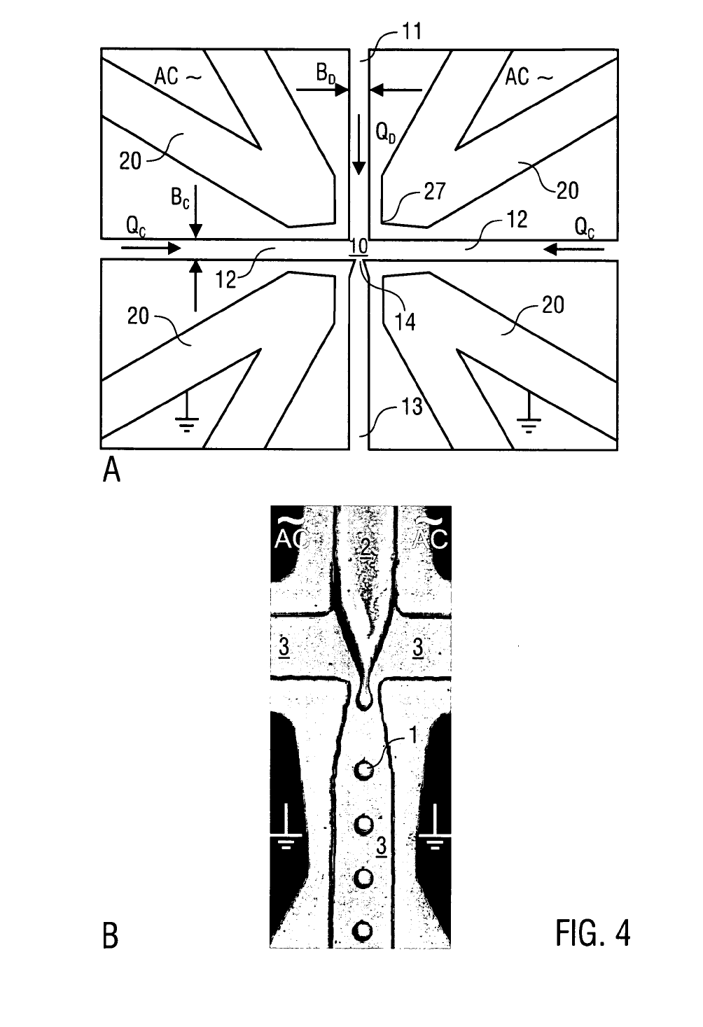

FIGS. 3A and 3B: schematic and photographic views of a cross-junction used according to the invention;

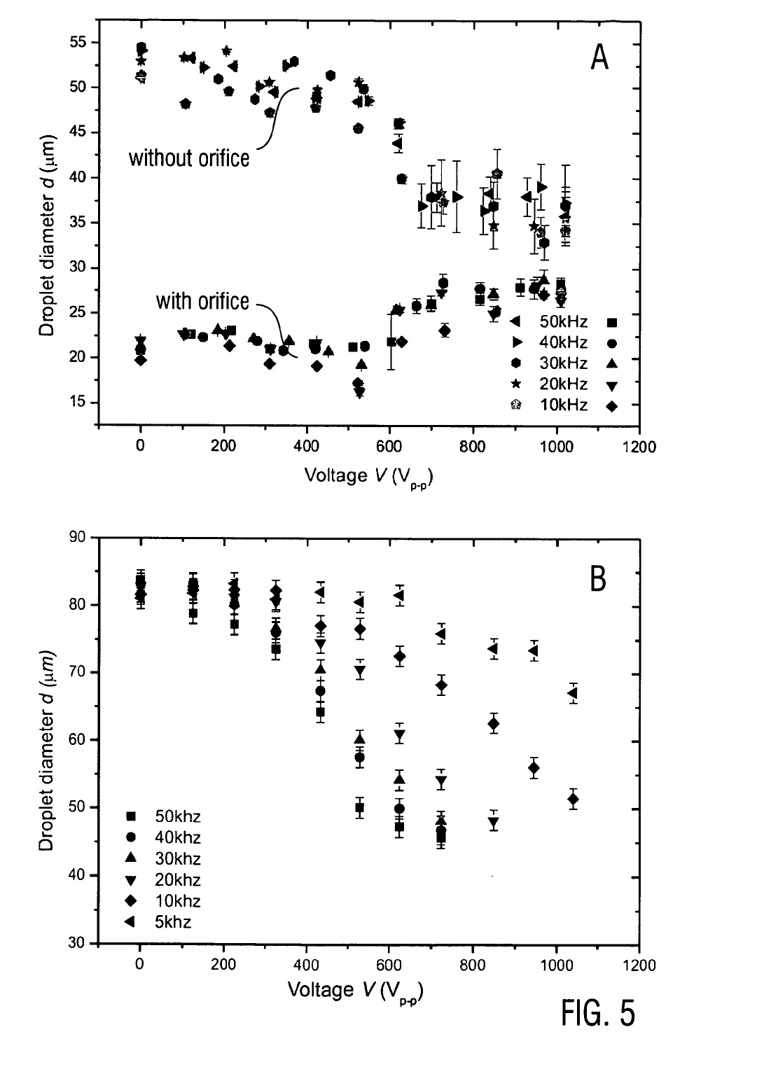

FIGS. 4A and 4B: schematic and photographic views of another cross-junction used according to the invention; and

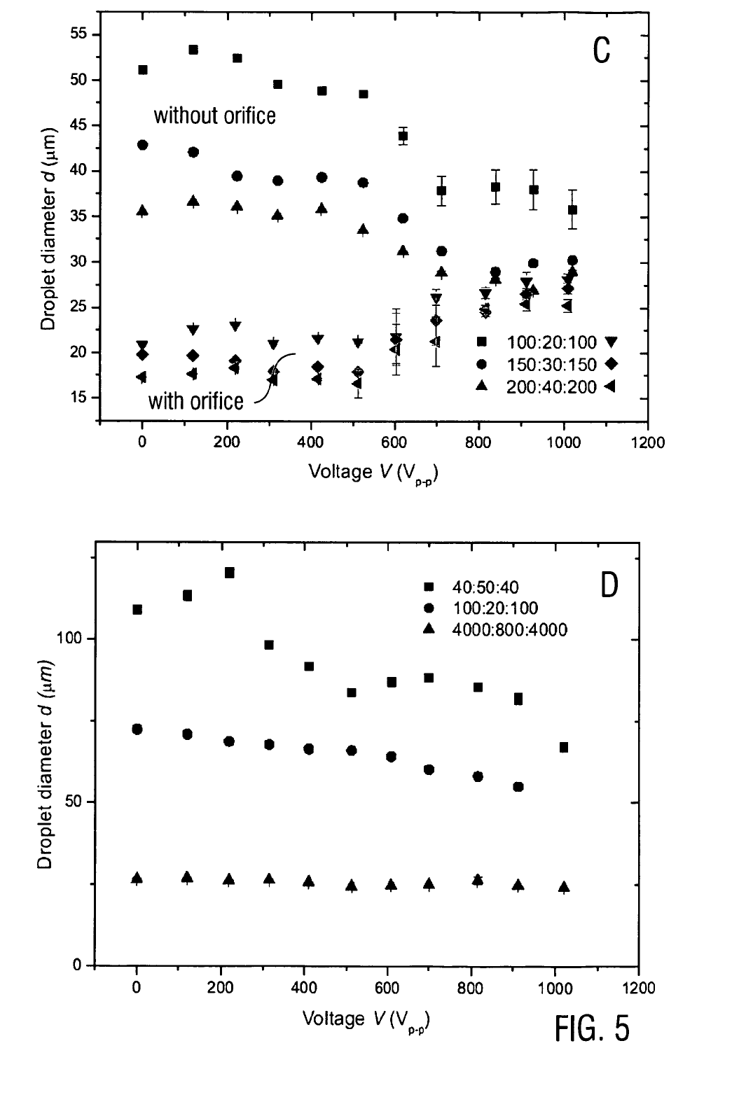

FIGS. 5A to 5D: graphical representations of experimental results obtained with the inventive droplet generation.

Embodiments of the inventive method and microfluidic device for generating droplets of a dispersed phased fluid in a continuous phase fluid are described in the following with exemplary reference to the droplet generation at a cross-junction or a coaxial jet junction in a microfluidic device. It is emphasized that the implementation of the invention is not restricted to these types of junctions, but rather possible with another channel junction design, in particular having other geometries and/or other numbers of dispersed phase channels or continuous phase channels. The invention is described with particularly reference to the effect of the electric fields controlling the droplet generation. Details of the microfluidic device, e.g. like the manufacturing thereof, the coupling with fluid reservoirs or the operation of pump devices, like e.g. syringes, are not described as they are known as such from conventional microfluidic devices.

Exemplary reference is made in the following to immiscible fluids, like e.g. an aqueous solution providing the dispersed phase fluid and an oil providing the continuous phase fluid. It is emphasized that the implementation of the invention is not restricted to particular fluids, but rather possible with any immiscible fluids (liquids) being selected in dependence on the application of the invention. It is in particular possible that the dispersed phase fluid is an inhomogeneous fluid like e.g. a suspension of biological material, like biological cells or parts thereof, in a culture medium.

FIG. 1 illustrates a first embodiment of a microfluidic device 100 according to the invention (schematic cross-section side view). The microfluidic device 100 comprises a chip body 30 with a substrate 31 and a channel block 32. The substrate 31 is a solid plate made of glass or plastic or another inert dielectric material with a substantially plane shape. On an upper side of the substrate 31, the channel block 32 is arranged, which includes microfluidic channels, like e.g. the dispersed phase channel 11, electrodes 20 and electrical wires 24. The microfluidic channels comprise at least one dispersed phase channel and at least one continuous phase channel (see also FIGS. 2 to 4 below) having a rectangular cross-sectional shape with a typical cross-sectional dimension in the range of about 100 μm to 300 μm, e.g. 150 μm. The microfluidic channels are connected via tubings 33 with fluid reservoirs (not shown). The electrical wires 24 provide connections between the electrodes 20 and connectors 25, which are coupled with a control device 40. The connectors 25 are fixed to the channel block 32, e.g. using a glue 26, like a UV hardable glue.

The channel block 32 is made of a dielectric material, like e.g. glass or plastic. In a preferred example, the channel block is made of a polymer, like PDMS (Polydimethylsiloxan). The channel block 32 has a plane surface facing to the substrate 31. The microfluidic channels, like the dispersed phase channel 11 and the electrodes 20 are provided on the lower surface of the channel block 32. They are manufactured with micromachining methods or preferably soft-lithography techniques, which are known as such form micro-system technology. The electrodes 20 are made of e.g. Indium/Gallium/Tin low temperature solders and having a thickness of 50 μm. Preferably, the thickness of the electrode is the same as the channel height for the flow. In the illustrated example, the electrodes 20 have a planar shape, which facilitates the alignment of the electrodes 20 with the microfluidic channels. The electrode design can be implemented on the soft-lithography mask as a fluidic channel to ensure that they are aligned with the channels and have the same height.

However, it is not strictly necessary that the electrodes 20 have a planar shape, but rather possible that any type of electrode is used that provides an alignment with the microfluidic channels and allows the creation of an electric field oriented along one of the microfluidic channels, which provides the output channel (see below).

The electrodes 20 are arranged such that there is no electrical contact with the inner space of the microfluidic channels. The electrodes 20 are insulated relative to the microfluidic channels, e.g. by the material of the channel block 32. With alternative embodiments, the electric insulation can be obtained by a dielectric cladding of the electrodes. On the lower side (bottom side) of the substrate 31, a backplate electrode 23 is provided. Preferably, a transparent backplate electrode material is used, like e.g. an ITO coating or a mesh of backplate electrode wires.

FIG. 1 further illustrates a feedback loop 50 being arranged for adjusting a diameter of droplets generated with the microfluidic device 100. The feedback loop 50 includes a droplet diameter measuring device 51, which comprises e.g. a microscope or camera with an image processing unit, or an impedance measuring device integrated in the chip body. The droplet diameter measuring device 51 is connected with the control device generating the at least one alternating voltage.

Further details of the microfluidic channels, the formation of at a channel junction and the operation of the microfluidic device 100 are described below with reference to FIGS. 3 to 5.

FIG. 2 schematically illustrates a plan view of a further embodiment of the microfluidic device 100, wherein the junction 10 is a coaxial jet junction. The microfluidic device 100 comprises a chip body 30, which may be structured with a substrate 31 and a channel block 32 as shown in FIG. 1. Microfluidic channels are formed in the chip body 30, comprising a dispersed phase channel 11 and a continuous phase channel 12. The dispersed phase channel 11 is coaxially arranged in the continuous phase channel 12. The channel junction 10 is formed at the free end of the dispersed channel 11 within the continuous phase channel 12. Downstream relative to the channel junction 10, the continuous phase channel 12 provides the output channel 13.

The electrodes 20 comprise a first electrode pair 21 arranged on an upstream side of the channel junction 10 and a second electrode pair 22 arranged on a downstream side of the channel junction 10. The electrodes 20 are connected with a control device (not shown in FIG. 2) being arranged for applying alternating voltages to the electrode pairs 21, 22.

The implementation of the invention with the coaxial jet junction is not restricted to the geometry shown in FIG. 2. It is in particular possible to orient the coaxial jet junction in a horizontal (as shown) or a vertical direction.

For operating the microfluidic device 100, e.g. according to FIG. 1 or 2, droplets 1 are generated by flowing a dispersed phase fluid 2, e.g. an aqueous solution including a suspended biological material, through the dispersed phase channel 11 and a continuous phase fluid 3, e.g. an oil, through the dispersed phase channel 12. The flow rate is selected in the range from e.g. 1 μl/h to 1000 μl/h. In practical experiments, typically 20 μl/h for the dispersed phase and 100 μl/h for the continuous phase have been used. Alternating voltages are applied to the electrodes 20 such that an alternating electric field being oriented along the output channel 13 is created at the junction 10. Under the influence of the electric field, the droplet generation is effected as described with further details below.

FIG. 3A shows an enlarged top view on the channel junction 10 of a microfluidic device according to the embodiment of FIG. 1. FIG. 3B shows a photographic picture of the channel junction 10 of FIG. 3A wherein a droplet 1 has been formed in the continuous phase fluid 3. At the cross-junction 10, the dispersed phase fluid 2 is flowing into the flow of the continuous phase fluid 3, wherein under the influence of the electric field, the droplet 1 is separated from the inflowing dispersed phase fluid 2.

The channel junction 10 is a cross-junction formed by two straight, mutually perpendicular microfluidic channels. The first channel provides the dispersed phase channel 11 upstream of the channel junction 10 and the output channel 13 downstream of the channel junction 10, while the other channel provides two continuous phase channels 12. The channels are formed e.g. with a rectangular cross-section in the channel block 32 (see FIG. 1), with a channel width B_{C} or B_{D} of e.g. 60 μm and a channel height of e.g. 46 μm.

The microfluidic channels define four quadrants each accommodating one planar electrode 20. Each of the electrodes 20 is formed by electrode strips arranged with a V-shaped design, which is tapered towards the cross-junction 10. Each electrode 20 has a tip 27 facing to the channel junction 10. In the illustrated example, the tip 27 of each electrodes 20 provides a substantially rectangular shape. Advantageously, a location of maximum field strength is formed with this geometry in the centre of the channel junction 10. Thus, the droplet production can be triggered at the location of the maximum field strength. The electrodes 20 are arranged in the chip body with a distance from the microfluidic channels 11, 12 and 13 such that the fluids flowing in the microfluidic channels 11, 12, 13 are electrically insulated from the electrodes 20. The tip-to-tip distance between the tips 27 of the electrodes 20 is about 170 μm.

The electrodes 20 are connected with a control device 40 (see FIG. 1), which is adapted for applying at least one alternating voltage on the electrodes 20. Typically, the applied voltage is selected such that the first electrode pair 21 upstream of the channel junction 10 has a common potential and the second electrode pair 22 downstream of the channel junction 10 has a common potential. Preferably, the voltages are applied according to one of the following operation modi.

According to a first variant (as illustrated in FIG. 3), a common alternating voltage AC is applied to the first electrode pair 21, e.g. with an amplitude of 700 V, while the second electrode pair 22 is grounded. In this case, the optional backplate electrode 23 (see FIG. 1) is grounded as well. According to a second variant, the common alternating voltage AC is applied to the second electrode pair 22, while the first electrode pair 21 and the optional backplate electrode 23 are grounded. According to a third variant, which is similar to an electrowetting technique, a common alternating voltage AC is applied to both electrode pairs 21, 22, while the backplate electrode 23 is grounded. It is a particular advantage of the invention that different operation modi as summarized above are available as these operation modi make the inventive microfluidic device 100 versatile and usable within a large conductivity range. However, the implementation of the invention is not restricted to the above operation modi, but rather possible with other voltages, e.g. application of different voltages to the electrodes 20 of each of the electrode pairs.

FIG. 4 illustrates a modified variant of the embodiment of FIG. 3, wherein an orifice 14 is formed at the channel junction 10 at the begin of the output channel 13. The orifice 14 has a cross-sectional dimension of e.g. 20 μm. By the orifice 14, the sizes of the droplets 1 generated at the channel junction is influenced (see FIG. 5B).

It is an essential advantage of the invention compared with conventional techniques that the droplet diameter can be adjusted in dependency on the amplitude of the alternating voltage applied to the electrodes 20. This is further illustrated with experimental results shown in FIGS. 5A to 5D.

FIG. 5A shows the effect of different applied voltages and frequencies on the droplet diameter d with the embodiment of FIG. 3 (geometry without orifice, upper values) and with the embodiment of FIG. 4 (geometry with orifice 14, lower values). The results have been obtained with a dispersed phase fluid 2 comprising pure de-ionized water and a continuous phase fluid 3 comprising mineral oil with 5 wt % Span 80. The flow rate of the dispersed phase fluid 2 is 20 μl/h, and the flow rate of the continuous phase fluid 3 is 100 μl/h in each of the continuous phase channels 12. The voltage has been varied in the range from 0 V to 1000 V. The frequency has being varied in the range of 10 kHz to 50 kHz.

As a result of FIG. 5A, it has been found that the droplet diameter d can be varied with the orifice-free geometry of FIG. 3 in the range from about 55 μm to about 35 μm, while the geometry of FIG. 4 provides a variation in the range from about 20 μm to 30 μm. Furthermore, FIG. 5A shows the effect of the orifice 14. With the embodiment of FIG. 3 (without orifice 14) the droplet diameter is about two times bigger than with the embodiment of FIG. 4 (with orifice 14). This difference is due to the presence of the orifice 14, which restricts the flow of the fluids. Without the orifice, the droplet diameter is decreased with an increase of the applied voltage, while with the orifice 14, the droplet diameter increases with an increase of the applied voltage. FIG. 5A further shows that in both cases a transition of droplet formation occurs at around 600 V (peak-to-peak) furthermore, it has been found that the applied electric field elongates and stretches the dispersed “finger” downstream, and thus changes the sizes of the droplets formed.

While the frequency dependency in the example of FIG. 5A is relatively weak, a stronger frequency dependency has been found with the generation of droplets having an increased conductivity. FIG. 5B shows that the droplet diameter d of aqueous NaCl solution droplet (C=307 μS/cm) can be varied with the orifice-free geometry of FIG. 3 in the range from about 50 μm to about 90 μm.

With the voltage dependency of droplet diameter d shown in FIGS. 5A and 5B, the feedback loop 50 in FIG. 1 can be realized. With the droplet diameter and/or droplet frequency measuring device 51, e.g. the microscope, the droplet diameter and/or droplet frequency is measured through the transparent substrate 31. The control device 40 generates the at least one alternating voltage in dependency on the measured droplet diameter such that a preset droplet diameter is obtained.

FIG. 5C illustrates the effect of different flow rates at different applied voltages at a constant frequency of 50 kHz. With a fixed flow rate ratio which is set to be 10 in all measurements the flow rate of the dispersed phase fluid has been changed from 20 μl/h via 30 μl/h to 40 μl/h. At zero voltage, with increasing flow rate, the droplet diameter has been reduced with the orifice-free geometry (embodiment of FIG. 3), while the droplet diameter is nearly constant with the geometry provided with orifice 14 (FIG. 4).

FIG. 5D shows the droplet diameter d as a function of voltage using a different type of oil. In this case, the continuous phase fluid is HFE oil with 1 wt % PEG-PFPE block copolymer surfactant. This result confirms that the invention is applicable with multiple fluid systems.

The features of the invention disclosed in the above description, the figures and the claims can be equally significant for realizing the invention in its different embodiments, either individually or in combination.

1.-25. (canceled)

26. A method of generating droplets of a dispersed phase fluid in a continuous phase fluid, comprising:
flowing the dispersed phase fluid and the continuous phase fluid to a channel junction of at least one dispersed phase channel and at least one continuous phase channel;
applying at least one alternating voltage to at least two electrodes so that an alternating electric field is created at the channel junction; and
generating the droplets of the dispersed phase fluid in the continuous phase fluid flowing in an output channel of the channel junction, wherein
the dispersed phase fluid and the continuous phase fluid are electrically insulated from the at least two electrodes.

27. The method according to claim 26, wherein the droplets of the dispersed phase fluid are electrically neutral.

28. The method according to claim 26, wherein the at least one alternating voltage applied to the at least two electrodes is offset-free.

29. The method according to claim 26, wherein the channel junction is a cross-junction, a T-junction or a coaxial jet junction.

30. The method according to claim 26, wherein the at least one alternating voltage applied to the at least two electrodes has a frequency which has at least five times the value of a droplet frequency of generating the droplets.

31. The method according to claim 26, wherein the at least one alternating voltage applied to the at least two electrodes has a frequency of at least 5 Hz.

32. The method according to claim 26, wherein the at least one alternating voltage applied to the at least two electrodes has a frequency of at least 10 kHz.

33. The method according to claim 26, wherein the at least one alternating voltage applied to the at least two electrodes has a frequency of at most 1 GHz.

34. The method according to claim 26, wherein the at least one alternating voltage applied to the at least two electrodes has a frequency of at most 50 kHz.

35. The method according to claim 26, wherein the at least one alternating voltage applied to the at least two electrodes has an amplitude of at least 20 V.

35. The method according to claim 26, wherein the at least one alternating voltage applied to the at least two electrodes has an amplitude of at least 100 V.

37. The method according to claim 26, wherein the at least one alternating voltage applied to the at least two electrodes has an amplitude of at most 2000 V.

38. The method according to claim 26, wherein the at least one alternating voltage applied to the two electrodes has an amplitude of at most 1000 V.

39. The method according to claim 26, wherein an electrical conductivity of the dispersed phase fluid is equal 0 μS/cm.

40. The method according to claim 26, wherein an electrical conductivity of the dispersed phase fluid is at least 0.3 μS/cm.

41. The method according to claim 26, wherein an electrical conductivity of the dispersed phase fluid is at most 30000 μS/cm.

42. The method according to claim 26, wherein an electrical conductivity of the dispersed phase fluid is at most 3000 μS/cm.

43. The method according to claim 26, wherein the droplets of the dispersed phase fluid are generated with a frequency of at least 1 Hz.

44. The method according to claim 26, wherein the droplets of the dispersed phase fluid are generated with a frequency of at most 10 kHz.

45. The method according to claim 26, wherein the at least two electrodes are shaped such that the alternating electric field is oriented in parallel with a flow direction in the output channel of the junction.

46. The method according to claim 26, wherein the at least one alternating voltage is adjusted such that the alternating electric field is oriented in parallel with a flow direction in the output channel of the junction.

47. The method according to claim 26, wherein the electrodes comprise a first electrode pair located upstream of the junction and a second electrode pair located downstream of the channel junction, and the same voltage is applied to the electrodes of each of the first and second electrode pairs.

48. The method according to claim 22, wherein one of the first and second electrode pairs is connected to ground potential.

49. The method according to claim 26, wherein the junction has a backplate electrode which is connected with ground potential.

50. The method according to claim 26, wherein the droplets of the dispersed phase fluid are generated at a location of maximum field strength of the electric field.

51. The method according to claim 26, further comprising adjusting a droplet diameter of the droplets by setting at least one of the amplitude of the at least one alternating voltage and the frequency of the at least one alternating voltage.

52. The method according to claim 51, wherein the droplet diameter is adjusted using a feedback loop including a droplet diameter or droplet frequency measuring device connected with a control device which generates the at least one alternating voltage.

53. A microfluidic device, being configured for generating droplets of a dispersed phase fluid in a continuous phase fluid, comprising:
a channel junction of at least one dispersed phase channel, at least one continuous phase channel and an output channel, said channel junction being arranged for flowing the dispersed phase fluid and the continuous phase fluid into the output channel; and
at least two electrodes being arranged for creating an alternating electric field at the channel junction, wherein
the at least one dispersed phase channel, the at least one continuous phase channel and the output channel are electrically insulated from the at least two electrodes.

54. The microfluidic device according to claim 53, wherein the electrodes comprise a first electrode pair located upstream of the junction and a second electrode pair located downstream of the channel junction.

55. The microfluidic device according to claim 53, wherein the channel junction is a cross-junction, a T-junction or a coaxial jet junction.

56. The microfluidic device according to claim 53, wherein the channel junction has a backplate electrode which is connected with ground.

57. The microfluidic device according to claim 53, wherein the output channel has an orifice at the downstream side of the channel junction.

58. The microfluidic device according to claim 53, wherein the electrodes have a thickness equal to a height of the channels at the channel junction.

59. The microfluidic device according to claim 53, further comprising a feedback loop being arranged for adjusting the diameter of the droplets, said feedback loop including a droplet diameter or droplet frequency measuring device connected with a control device generating the at least one alternating voltage.
